(19) United States
(12) Patent Application Publication
(10) Pub. No.: US 2005/0248817 A1
(43) Pub. Date: Nov. 10, 2005

(54) Covert hologram design, fabrication and optical reconstruction for security applications

(75) Inventors: Samuel P. Weaver, Boulder, CO (US); Robert McLeod, Boulder, CO (US); Kevin R. Curtis, Longmont, CO (US); Adrian J. Hill, Lyons, CO (US)

Correspondence Address: MORRISON & FOERSTER LLP, 1650 TYSONS BOULEVARD, SUITE 300, MCLEAN, VA, 22102, US

(73) Assignee: InPhase Technologies, Inc., Longmont, CO (US)

(21) Appl. No.: 10/840,293

(22) Filed: May 7, 2004

(51) Int. Cl. G03H 1/04

(52) U.S. Cl. 359/2; 430/1; 430/2; 283/86

(57) ABSTRACT

Disclosed is an article having a holographic recording medium having digital data that cannot be seen by human eye, wherein the holographic recording medium is a holographic material that records volume holograms that permit authentication of the article and the holographic material is attached to or part of the article. Also disclosed is a method of authentication of the article.

### TECHNICAL FIELD

The present invention relates to storage of data in holographic media. In particular, the present invention relates to storage of covert holographic data in an article having a holographic recording medium.

### BACKGROUND

Holography is a familiar technology for displaying three dimensional images. Basically, two coherent light beams are caused to intersect in a holographic medium. An interference pattern or grating pattern results that is unique to the two beams and which is written into the medium. This grating pattern is referred to as the hologram and has the property that if it is illuminated by either of the beams used for recording, the illuminating beam diffracts in the direction of the second writing beam. To an observer, it appears as if the source of the second beam is still present at an observation plane.

There are two significant types of holograms to consider: surface relief holograms and volume holograms. Surface relief holograms act on an incident optical wavefront by imparting a local phase shift which is proportional to the holographic material height at a specific location. In a surface relief hologram, local optical path length is proportional to the physical path length at a specific location. Volume holograms act on an incident optical wavefront by imparting a local phase shift which is proportional to the index of refraction of the holographic material at a specific location. In a volume hologram, local optical path length is proportional to the index of refraction at a specific location, while the physical path length does not vary in the holographic material.

Holograms are becoming more common for use in other types of applications such as security and data storage. In data storage applications, as is well understood by those skilled in the art, a page of data is used as a source image and a detector array is placed at the observation plane. Additionally, due to Bragg effects, many holograms may be multiplexed within the same volume of holographic material by slightly changing the angle of the reference beam with each different data page. Large numbers of holograms can be multiplexed this way in a small volume of recording material, providing high data storage potential. A complete discussion of storage holograms can be found, for example, in John R. Vacca, Holograms & Holography Design, Techniques, & Commercial Applications, Charles River Media, Inc., 2001 (“Vacca”). Generally, data stored in holographic media is only machine readable.

With respect to security applications, it is well known to include holograms on credit cards to prevent duplication of these items. A hologram is useful in this context because of the relative difficulty involved in counterfeiting a hologram as compared to printed designs, embossed features and even photographs. However, security holograms used on credit cards are generally embossed only on the surface of the card. As such, while holograms in general are relatively difficult to duplicate, a hologram on the surface of a card can be somewhat easier to duplicate or alter.

One potential solution to the problems associated with relative ease of duplication of surface holograms is offered in U.S. Pat. No. 6,005,691 for “High-Security Machine-Readable Holographic Card” to Grot et al. Grot et al. discloses a hologram card which includes a first plastic material formed to include localized topological features constituting a diffractive optical element. The diffractive optical element is structured to generate a hologram image. The hologram card also includes a protective layer which is chemically bonded to and directly contacts the topological features constituting the diffractive optical element. While the hologram card of Grot et al. includes a protective layer to make any hologram included in the diffractive element more difficult to duplicate, the card includes only a surface hologram, which holds a relatively small amount of information. That is, the hologram card disclosed in Grot et al. is relatively inefficient.

Additionally, while credit cards, and drivers licenses and identification cards, can typically store some information in a magnetic stripe often included with such cards, the amount of information such magnetic stripes can store can be relatively low.

Holographic labels, seals, and markers of all appearances and types are increasingly being used for security applications in diverse arenas of activity such as credit card identification, document authentication, currency security, branding of commodities, unique marking of software and pharmaceuticals, and numerous other applications. Within the class of holographic appliqués, the machine-embossed foils most frequently used are called diffractive optically variable image devices (DOVIDs, OVIDs, OVDs). These devices are affixed permanently or semi-permanently to the devices or commodities that they mark, and their bright, three-dimensional appearances attract attention and identify the commodity as genuine. As might be expected, unscrupulous dealers of counterfeit products attempt to replicate these holographic markers to make their products appear genuine. In response, the manufacturers of these holograms have implemented approaches such as hidden or latent images embedded in the visible hologram that can be viewed only with a specialized optical reader. Another feature becoming widely employed within these holograms is machine-readable product identification markings, such as embedded UPC bar codes. Both optical and electron-beam mastering techniques are used to produce these modern holographic foils which multiplex visible images with machine-readable data within a single embossed foil patch.

### SUMMARY OF THE INVENTION

An embodiment of this invention is an article comprising a holographic recording medium comprising digital data that cannot be seen by human eye, wherein the holographic recording medium is a holographic material that records volume holograms that permit authentication of the article, further wherein the holographic material is attached to or part of the article.

Preferably, the digital data is formatted in a two-dimensional page format. Preferably, the holographic recording medium is a holographic material that records volume holograms. Preferably, the holographic material that records volume holograms is a volume hologram layer. Preferably, the thickness of the volume hologram layer is such that human eye cannot substantially discern the digital data in visible light. Preferably, the fringe period of the data holograms stored in the holographic media is such that only light that is invisible to the human eye diffracts from the data holograms. In another variation, the diffraction efficiency is low enough that the human eye cannot substantially discern the digital data in visible light.

A further embodiment of the article comprises a visible image in the holographic recording medium. Preferably, the visible image is a hologram that diffracts light that is both visible and invisible to human eye. Preferably, the article comprises a patch capable of being attached to a document, a card, a banknote or merchandise. Preferably, the article further comprises a transparent protective layer overlaying the holographic recording medium. Preferably, the digital data is machine readable holographic data. Preferably, the holographic recording medium has multiple data sections for storing the digital data and other information. Preferably, the other information is visible to human eye.

Yet a further embodiment of the article further comprises a substrate layer and a laminating layer overlaying a protective layer. Preferably, the digital data includes multiplexed holographic data. Preferably, the volume hologram layer comprises a photo sensitive polymer.

Preferably, the digital data is multiplexed in substantially a same location as that of an image hologram visible to human eye. Preferably, the digital data is patterned as a two-dimensional array of data bits. Preferably, the digital data is patterned as a series of digital data that is read by a scanner. In another variation, the digital data is a full page of digital data. More preferably, the digital data are recorded with a reference beam that is spatially encoded using phase, or amplitude, or both thereby requiring an encoded readout beam to be read the digital data. Preferably, the digital data are recorded and read by UV light.

A further embodiment of the article comprises modulation marks for timing and/or positional servo. Preferably, a layer of a photosensitive material is positioned above an optically reflective surface, an optically transmissive surface or an optically absorptive surface. Preferably, the digital data is written into the holographic recording medium before assembling components of the article into the article. More preferably, the digital data is written into the holographic recording medium after assembling components of the article into the article. Preferably, the article is a document, a card, merchandise or a banknote.

Another embodiment is a method of authentication of the article comprising obtaining the article, reading the digital data and determining the authenticity of the article. The method could further comprise optically storing the digital data as an image at an image plane by interfering a coherent reference beam with a beam of a two-dimensional image. Preferably, the digital data is arranged in a parallel barcode fashion. In another variation, the digital data is arranged in a pagewise fashion. Preferably, the beam of a two-dimensional image is passed through an intervening optical system that is a spherical afocal telescopic system comprising a multiplicity of optical elements. Preferably, the intervening optical system is an afocal telescopic system comprising two spherical optical lens groups, positioned physically to bring the focal positions of the two spherical optical lens groups into coincidence. Preferably, a single cylindrical focusing optical element is also employed for light efficiency. In one variation, a combination of cylindrical and spherical imaging optical elements are employed.

### BRIEF DESCRIPTION OF THE DRAWINGS

FIG. 1—Reader system with spherical optics and a 2D parallel output.

FIG. 2—Reader system with spherical optics and a 1D linear output.

FIG. 3—Reader system with spherical and cylindrical optics and a 1D linear output. This system is more light-efficient than the system illustrated in FIG. 2.

### DETAILED DESCRIPTION

Holographic storage media can take advantage of the photorefractive effect described by David M. Pepper et al., in “The Photorefractive Effect,” Scientific American, October 1990 pages 62-74. Photorefractive materials have the property of developing light-induced changes in their index of refraction. This property can be used to store information in the form of holograms by establishing optical interference between two coherent light beams within the material. The interference generates spatial index of refraction variations through an electro-optic effect as a result of an internal electric field generated from migration and trapping of photoexcited electrons. While many materials have this characteristic to some extent, the term “photorefractive” is applied to those that have a substantially faster and more pronounced response to light wave energy.

Of more interest are photopolymer recording materials. With these materials the variations in light intensity generate refractive index variations by light induced polymeration and mass transport. See Larson, Colvin, Harris, Schilling “Quantitative model of volume hologram formation in photopolymers,” J Appl. Phy. 84, 5913-5923 1996. Also photochromatic materials can be used. These materials convert light variation into index variation through structural changes or isomerazations.

A holographic recording medium includes the material within which a hologram is recorded and from which an image is reconstructed. A holographic recording medium may take a variety of forms. For example, it may comprise a film containing dispersed silver halide particles, photosensitive polymer films (“photopolymers”) or a freestanding crystal such as iron-doped LiNbO₃ crystal. U.S. Pat. No. 6,103,454, entitled RECORDING MEDIUM AND PROCESS FOR FORMING MEDIUM, generally describes several types of photopolymers suitable for use in holographic storage media. The patent describes an example of creation of a hologram in which a photopolymer is exposed to information carrying light. A monomer polymerizes in regions exposed to the light. Due to the lowering of the monomer concentration caused by the polymerization, monomer from darker unexposed regions of the material diffuses to the exposed regions. The polymerization and resulting concentration gradient creates a refractive index change forming a hologram representing the information carried by the light.

In volume holographic storage, a large number of holograms are stored in the same volume region of a holographic recording medium. Multiple holograms can be recorded in a recording medium using an exposure schedule that equalizes the amplitudes. There are several methods of holographic storage such as, angle multiplexing, fractal multiplexing, wave length multiplexing and phasecode multiplexing.

Angle multiplexing is a method of for storing a plurality of images within a single recording medium. Such angle multiplexing is described by P. J. van Heerden in, “Theory of Optical Information Storage In Solids,” Applied Optics, Vol. 2, No. 4, page 393 (1963). Angle multiplexing generally involves maintaining a constant angle spectrum for an information carrying object beam, while varying the angle of a reference beam for each exposure. A different interference pattern thereby can be created for each of a plurality of different reference beam angles. Each different interference pattern corresponds to a different hologram. Angle multiplexing thus allows a larger number of holograms to be stored within a common volume of recording medium, thereby greatly enhancing the storage density of the medium.

U.S. Pat. No. 5,793,504 entitled “Hybrid Angular/Spatial Holographic Multiplexer,” describes a method of angularly and spatially multiplexing a plurality of holograms within a recording medium. According to that patent, since diffraction efficiency of stored holograms varies, at least approximately, inversely with the square of the number of holograms stored, there is a limit to the number of holograms that can be stored within a given volume of a particular recording medium. Therefore, spatial multiplexing is employed to store different sets of holograms in different volume locations within a recording medium. The patent states that storing sets of holograms in spatially separated locations mitigates the problem of undesirable simultaneous excitation of holograms from different sets by a common reference beam. Spatial multiplexing typically does not increase the media's density, just its capacity.

A method of phase correlation multiplexing is disclosed, for example, in U.S. Pat. No. 5,719,691 to Curtis et al. entitled “Phase Correlation Multiplex Holography” which is hereby incorporated herein in its entirety by reference. In one embodiment of phase correlation multiplex holography, a reference light beam is passed through a phase mask, and intersected in the recording medium with a signal beam that has passed through an array representing data, thereby forming a hologram in the medium. The spatial relation of the phase mask and the reference beam is adjusted for each successive page of data, thereby modulation the phase of the reference beam and allowing the data to be stored at overlapping areas in the medium. The data is later reconstructed by passing a reference beam through the original storage location with the same phase modulation used during data storage.

Data recorded in the article of this invention is preferably, though not necessarily, recorded in a holographic material layer after forming the article. Examples of reader/recorders which can be used by user in such a circumstance is disclosed, for example, in H. J. Coulfal et. al, Holographic Data Storage C. Springer-Verlag 2000, pp. 343-357 and 399-407, which is hereby incorporated by reference herein in its entirety. As discussed in Coulfal, such reader/recorders can also be used to read holographic data already stored in an article in the form of a card. It is also considered to record the data before holographic material layer has been laminated with the article of this invention.

A preferred article in accordance with the present invention includes a multi-layer holographic structure such as a card, a patch, or appliqué for use on merchandise having sections for containing holographic machine readable data as well as for containing security and/or presentation information which may be either machine or human readable and may also be holographic. The article of this invention is preferably constructed of multiple layers and preferably includes at least a data layer and a protective layer overlaying the data layer. By including the protective layer, information placed in the data layer can not be altered without removing the protective layer, thereby destroying the article of this invention. In this way, information placed in the data layer is advantageously more secure than if the protective layer was not provided. Additionally, information placed in the data layer can include volume holograms, allowing many holograms to be multiplexed at the same location. Multiplexed digital image patterns can be used to store information that is relatively difficult to replicate. This can advantageously make such a article of this invention relatively difficult to counterfeit.

The article of this invention could be small (e.g. stamp sized) or large (e.g. book size). Additionally, while article of this invention is in the form of a rectangle, a holographic article of this invention in accordance with the present invention can be any shape including, without limitation, a square, circle, triangle or toroid. Deterring counterfeiting would be important for applications such as driver's licenses, credit cards, ID cards, monetary currency, or content distribution.

Digital data is preferably contained in the volume of a holographic material layer. Additional holographic data can include, without limitation, images of the user; fingerprint, voice or other user biometric data; and/or holographic patterns to make the article difficult to copy. In addition, the article could have presentation data in a presentation/security section of the article. The presentation data can include, without limitation, a company name, company logo, user name, and user contact information. Some or all of this information can also be included in a holographic material layer in non-holographic form. For example, without limitation, a company logo or user contact information could be included in non-holographic form while other presentation/security information could be included in holographic form.

As used herein, a volume hologram indicates that an index of refraction change exists in the volume of the holographic material layer as opposed to existing merely at the surface of the holographic layer, as disclosed in Grot et al. discussed in the background section. Volume holographic data stored in holographic material layer can have a higher refractive efficiency than holograms placed on the surface of a foil (such as surface relief or embossed holograms). A surface relief hologram typically can refract only up to about 10% of the light incident on the hologram. However, a hologram in a translucent holographic material in the article of this invention can diffract up to 100% of the light incident thereon. As such, a hologram of the article of this invention can be relatively more visible and brighter to the eye that a surface hologram when the thickness of the volume holographic material is chosen correctly. Additionally, the images may be two dimensional or three dimensional holograms and more images can be recorded in a holographic material layer than in a surface hologram. For example, it is possible to multiplex 20-50 holograms with 100% efficiency each in a volume material while multiplexing that many in a surface relief fashion would typically result in efficiencies of approximately 10⁻⁴ (that is, 0.01% of the light incident on the multiplexed surface relief holograms would be refracted). This would result in a hologram which would be relatively difficult to view. Recording of holograms in a holographic material such as a holographic material layer is well known to those skilled in the art and discussed, for example, in Vacca. Additionally, presentation/security data could be single or multiplexed holograms. If holograms are multiplexed digital image patterns, the data would be relatively difficult to reproduce. Specifically, as discussed in Curtis et al., using phase encoding to store an image requires highly precise matching of recording conditions to detect the image signal. As such, recording using phase encoding patterns can facilitate verification of article authenticity.

A method of making a holographic multi-layer structure having multiple layers in accordance with the present invention is disclosed in U.S. Pat. No. 5,932,045 entitled “Method for Fabricating a Multilayer Optical Article” issued to Campbell et al. on Aug. 3, 1999 (“Campbell”) which is hereby incorporated by reference herein in its entirety. The multi-layer structure could have protective layer and substrate layer affixed to a holder by vacuum, electrostatic force, magnetic attraction or otherwise. A holographic material layer could be placed between the protective layer and the substrate layer and then cured.

It is possible for the adherent to be photocurable or otherwise curable, e.g., radiation or chemical curable. Heat may be used to accelerate a radiation cure. When using the above method, it is preferable for the adherent to be a material that undergoes a phase transformation, e.g., liquid to solid, to attain a required adherence. As used herein, the terms cure and curable are intended to encompass materials that gel or solidify by any such methods. Photocurable adherents include materials that cure upon exposure to any of a variety of wavelengths, including visible light, UV light, and x-rays. It is also possible to use adherents that are curable by electron or particle beams. Useful adherents include photocurable adherents that are photosensitive, the term photosensitive meaning a material that changes its physical and/or chemical characteristics in response to exposure to a light source (e.g., selective, localized exposure). Such photosensitive adherents include but are not limited to certain photosensitized acrylates and vinyl monomers. Photosensitive adherents are useful because they act as both an adherent and a recording media.

It is possible for the adherent to comprise additives such as adherence-promoters, photoinitiators, absorptive materials, or polarizers. The thickness of the post-cure adherent will vary depending on several factors, including the adherent used, the method of application, the amount of adherent applied, and force exerted on the adherent by the substrates. Different thickness will be desired for different applications. Preferably, however, a holographic material layer is a volume layer with a thickness of 5 microns to 6 mm. The level of cure needed is determined by the particular adherent used and by the force required to maintain a substrate or multilayer article with the encased optical article in the position imparted by the holder or holders. For materials that are photocurable, heat curable, or chemically curable, it is possible for suitable cures to range from a few percent to 100%.

Additionally, in the method described above, a holographic material layer could be formed by mixing a matrix precursor and a photoactive monomer. Such a holographic medium is disclosed in U.S. Pat. No. 6,103,454 which is hereby incorporated in its entirety by reference. One advantage of using this type of media is that the article of this invention can be made to have relatively good transmitted wavefront quality (that is, the article of this invention looks optically flat). Specifically, using the method and media discussed above, a holographic article in accordance with the present invention, which is an article of this invention, can easily be made to have a reflected or transmitted optical flatness which exceeds λ/2 per centimeter squared at a wavelength of 780 nm measured interfermetrically. Transmitted optical flatness is a measure of the deviation, from a predetermined profile, of an optical path length through an optical article. Such a measure is well known to those skilled in the art and discussed, for example, in Campbell et al., which has been incorporated by reference. Such optical flatness can advantageously make the article of this invention relatively high performance and relatively simple. In particular, holograms can be recorded in a holographic material layer at a relatively high density and at a relatively high signal to noise ratio. Additionally, data can be transferred both to and from a holographic article of this invention having the cited flatness at relatively high transfer rates. The above described method of fabricating a holographic article in accordance with the present invention can also reduce wedge (increasing or decreasing thickness in a direction parallel to the surface of the article of this invention). By these methods the wedge of the entire article of this invention can be made to be less than a 20 wavelengths as measured interferometrically at 780 nm. That is, the thickness over the entire surface of the article of this invention will not vary more that 20 wavelengths when measured using a 780 nm light beam. Such a measure is well known to those skilled in the art and discussed, for example, in Campbell et al., which has been incorporated by reference.

Another medium from which a holographic material layer may be fabricated can be a member of a class described and claimed in U.S. Pat. No. 5,719,691 to Colvin et al. for a “Photo Recording Medium” which is hereby incorporated by reference herein in its entirety. Briefly, it is an all-acrylate composition constituted of an oligomeric matrix and dispersed monomer, which together, under the influence of a photoinitiator, respond to illumination by local polymerization to increase refractive index. The specific composition is:

| Component | Percent by Weight |
|---|---|
| isobornyl acrylate | 37.23 |
| oligomeric urethane acrylate | 55.84 |
| photoinitiator | 5.96 |
| tertiary butyl hydroperoxide | 0.97 |

However, the medium of a holographic material layer could also be any acrylate-based photopolymer, or other suitable holographic medium such as, without limitation, a film containing dispersed silver halide particles or a free-standing LiNbO3 crystal. As discussed above, exposing holographic storage or presentation/security data into a holographic material layer is well understood by those skilled in the art.

Protective layer and substrate layer of the article of this invention can be fabricated from either the same or different materials. The materials from which protective layer and substrate layer can be formed include, without limitation, ceramics (including glasses), silicon, metals, polycarbonate, polymethylmethacrylate, or acrylic, or plastics. In addition to self supporting substrates such as glass plates, it is possible for the substrate to be a polymeric material that is sprayed onto a holder, a thin polymer film such as Mylar®, or a polymer sheet such as polycarbonate. It is also considered that a polymeric material or film be combined with a self supporting material such as a glass plate to form a single substrate. Either or both protective layer and substrate layer may be an optical article such as, with limitation, a polarizer, half or quarter wave plate, neutral density filter, birefrengement plate, or diffractive optic.

The article could also have a laminating layer that is preferably transparent and can be made from the same material as the protective layer discussed above. The article could have a non-holographic layer that can be fabricated from any suitable material depending upon the nature of the non-holographic data contained therein. For example, without limitation, if the non-holographic layer could be a photograph, the fabrication material would be a photographic or printed paper or emulsion. If the non-holographic layer is text data or a printed symbol, the fabrication material could be printed paper or plastic.

The card, patch, merchandise or banknote shaped article of the preferred embodiment can be manufactured in substantially the same way as the article of this invention discussed above. In particular, the substrate layer, holographic media layer and protective layer can be laminated. Then, the non-holographic layer can be placed on or in the protective layer as is well understood by those skilled in the art and the laminating layer can be placed thereover, as is also well understood by those skilled in the art. Additional details are available in U.S. Pat. No. 6,695,213, which is incorporated herein by reference.

The security and presentation holograms could be recorded or mastered at time of fabrication of the article of this invention or the user could use the corresponding writer to recorded user specific holograms into these areas of the article of this invention. These user recorded holograms could be either machine readable or visible to the eye.

In order to produce a holographic security foil, a visible image and/or a concealed (latent) image and/or a data pattern are designed. If optical methods are used to construct initial holographic master, then masks or models of each constituent portion of the final hologram are constructed, and an optical hologram is exposed which combines all of the desired imagery in a single holographic master. This master is composed of volume index of refraction structures called fringe patterns that reconstruct the desired images upon illumination with light of the appropriate properties

One embodiment of this invention relates to a particular design approach for volume (non surface relief) security holograms that enables data and/or images to be stored which are entirely invisible when viewed by the human eye. In addition, these covert data pages and/or covert images are more difficult to detect and to reproduce than those produced through non-volumetric holographic data storage. These highly covert data and images can be multiplexed with a visible holographic image, and can also be multiplexed with any other security hologram data storage or imaging approach employed currently. A particular class of holograms with a reflective backing allows for customized data to be stored in situ. This customization can improve the security of the product (CD, DVD, clothing, etc) or document by combining the data stored with other security features or information such as serial number, manufacturer, etc. Examples of systems that can read and write holograms into polymer films are given.

Preferably, the construction of any material arrangement of the article of this invention comprises of one or more layers of photosensitive media to accomplish volume holographic data storage for any security or authenticity verification applications. In one embodiment, a photosensitive medium is applied in a single (or multiplicity of optically thick or thin (>5 micron) layer(s) upon a substrate or within a material stack. A single (or multiplicity of volume holographic fringe pattern(s) can be recorded in this (these) layer(s) using any one of several well-known multiplexing techniques (angle multiplexing, shift multiplexing, correlation multiplexing, etc.). The material arrangement that contains the photosensitive material can be constructed such that the photosensitive medium is located above an optically reflecting material, or above an optically transparent material or above an optically absorptive material.

The material arrangement could comprise of one or more layers of photosensitive media greater than 5 microns in thickness to accomplish volume holographic data or image storage for any security or authenticity verification applications. The one or more of the layers of the photosensitive material(s) could comprise a formulation such as those described in U.S. patent application Ser. Nos. 10/146,115, 10/166,172 and 10/207,158 which are incorporated herein by reference. The one or more of the layers of the photosensitive material(s) could be positioned above an optically reflective surface, above an optically transmissive surface or above an optically absorptive surface.

For a photosensitive medium above a reflective surface, the angle between the writing beams can have any value between zero and 180, and the orientation between the plane of data modulation and the plane of the recording medium can be any value between −90 and 90 degrees. For a photosensitive medium above a transmissive surface, the angle between the writing beams can have any value between zero and 360, and the orientation between the plane of data modulation and the plane of the recording medium can be any value between −90 and 90 degrees. The optical system required to reconstruct the original data pattern from volume holograms will be more complicated for cases of non-zero values of the orientation between the data-modulated plane and the recording medium plane than it will be for cases in which the data-modulation plane is parallel to the hologram recording plane.

To combine the covert data with a visible image can be desirable to hide the data more effectively. This can be done by placing normal artwork under the transmissive polymer, placed a prerecorded holographic film on top of a foil hologram, and or recording another strong visible hologram into the same polymer film as the data hologram. By recording the data at angles or with wavelengths that are not used for the visible hologram and making the diffraction efficiency weak the data can be made more covert. Also by using data pixels or bars that are fairly small (10-100 microns) the data will be harder to detect by eye. Recording the data hologram in the polymer film outside of the image plane also makes the data more covert. This covertness is limited by the surface quality of the polymer film.

The use of the optical writing and reading systems described in this disclosure for writing security holograms are similar to those contemplated for holographic data storage. The combination of data storage and allowing for in situ recording onto holographic patches, stripes, foils, windows for use in security of products and documents is novel. These holographic recording materials can be attached to documents or products or integrated into the actual structure, for example as in some plastic currency in use today, layered into/onto CD or DVD, or plastic credit cards. The systems shown below use transmissive optical elements to image but reflective imaging systems are equally suitable.

The data to be stored can be arranged for readout in a line, bit by bit, bit by bit but parallel independent streams, barcode, or pagewise. Examples include: storing the data in a fashion similar to CD or DVD bit patterns holographically, reading out a line of bar codes in parallel with a line detector, or a 2D data pattern readout out in parallel by imaging or line by line by using a line detector and moving the hologram in with respect to the optical system. The data would have error correction, channel modulation and timing/servo marks recording into the hologram with the data. A single layer of data can be stored or multiple virtual layers can be stored by using volume multiplexing techniques.

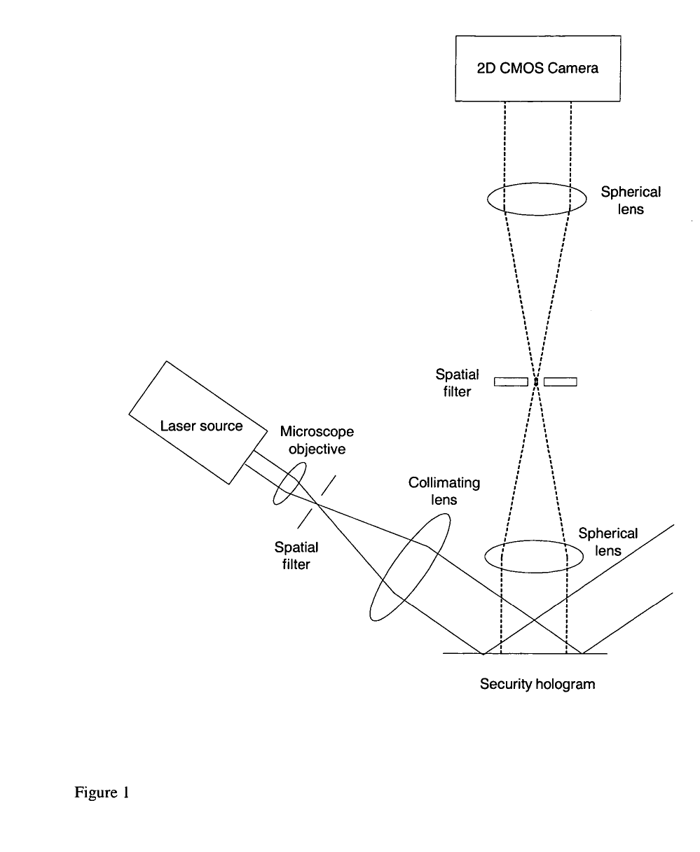

One embodiment of a reader system is shown in FIG. 1, which depicts a reader system with spherical optics and a 2D parallel output. This approach requires stopping (or slowing) the hologram briefly to capture a 2D image on the output camera. As in all of these designs, the afocal imaging telescope could be replaced with a single lens element, if image quality and positioning tolerances are found to be acceptable. If magnification is required for pixel-matching between the input and output planes, the telescope approach is likely to be required. The 2D output approach will probably have tighter rotational requirements on the detector array (camera) than would be the case using a linear array.

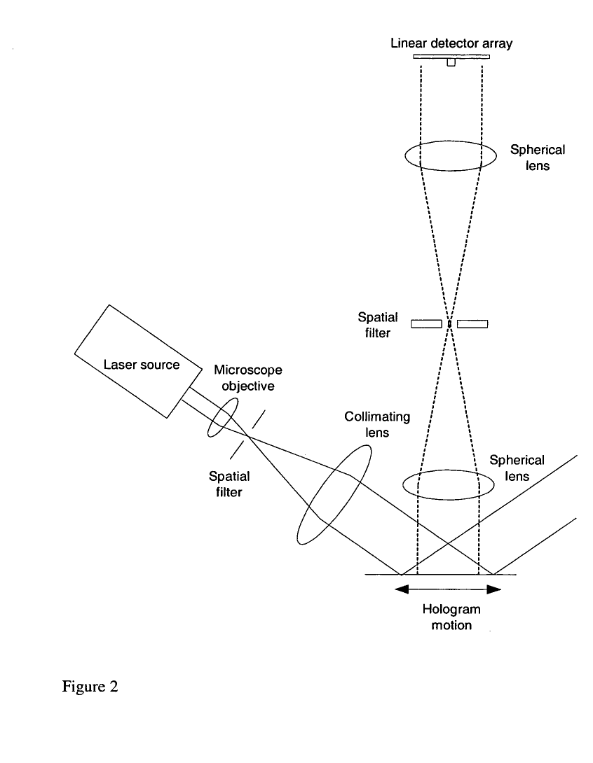

A second embodiment of a reader system is shown in FIG. 2, which shows a reader system with spherical optics and a 1D linear output. This approach requires continuous or stepped motion of the input hologram past the center of the illuminating beam. As in all of these designs, the afocal imaging telescope could be replaced with a single lens element, if image quality and positioning tolerances are found to be acceptable. If magnification is required for pixel-matching between the input and output planes, the telescope approach is likely to be required. This approach is not as light efficient as using a line focus to illuminate the hologram, but with the correct sizing of the collimated beam, it could be acceptable. The hologram might be pressed against roller to make flat as moved across reader.

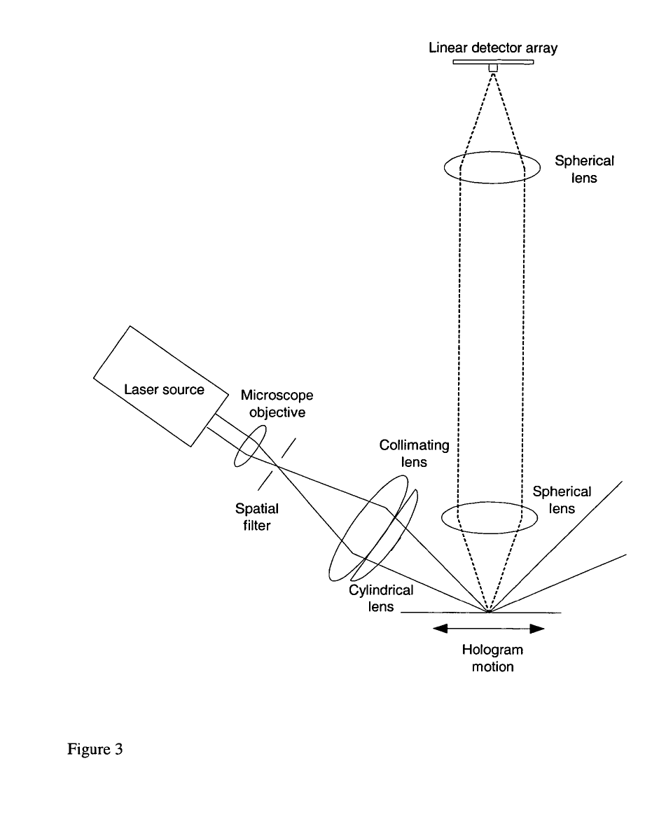

A third embodiment of a reader system is shown in FIG. 3, which shows a reader system with spherical and cylindrical optics and a 1D linear output. This approach requires continuous or stepped motion of the input hologram past the center of the illuminating beam. As in all of these designs, the afocal imaging telescope could be replaced with a single lens element, if image quality and positioning tolerances are found to be acceptable. If magnification is required for pixel-matching between the input and output planes, the telescope approach is likely to be required. This approach is very light efficient.

The reader system could also be a barcode reader or a page-code reader. The patents publications that are incorporated herein by reference include U.S. Pat. No. 6,482,551, U.S. Pat. No. 5,932,045, U.S. Pat. No. 5,306,899, and Japanese J. Appl. Phys. Vol. 42 (2003) pp 976-980.

The foregoing descriptions of specific embodiments of the present invention have been presented for purposes of illustration and description. They are not intended to be exhaustive or to limit the invention to the precise forms disclosed, and it should be understood that many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. Many other variations are also to be considered within the scope of the present invention.

1. An article comprising a holographic recording medium comprising digital data that cannot be seen by human eye, wherein the holographic recording medium is a holographic material that records volume holograms that permit authentication of the article, further wherein the holographic material is attached to or part of the article.

2. The article of claim 1, wherein the digital data is formatted in a two-dimensional page format.

3. The article of claim 1, wherein the holographic recording medium is a holographic material that only records volume holograms.

4. The article of claim 1, wherein the holographic material that records volume holograms is a volume hologram layer.

5. The article of claim 4, wherein a thickness of the volume hologram layer is such that human eye cannot substantially discern the digital data in visible light.

6. The article of claim 1, wherein the digital data are in a form of data pixels smaller than 100 microns.

7. The article of claim 1, wherein the digital data are in a form of bar codes.

8. The article of claim 1, wherein the article is a document, a card, merchandise or a banknote.

9. The article of claim 1, further comprising a visible image in the holographic recording medium.

10. The article of claim 9, wherein the visible image is a hologram that diffracts light that is both visible and invisible to human eye.

11. The article of claim 1, wherein the article comprises a patch capable of being attached to a document, a card, a banknote or merchandise.

12. The article of claim 11, wherein the article further comprises a transparent protective layer overlaying the holographic recording medium.

13. The article of claim 1, wherein the digital data is machine readable holographic data.

14. The article of claim 1, wherein the holographic recording medium has multiple data sections for storing the digital data and other information.

15. The article of claim 14, wherein the other information is visible to human eye.

16. The article of claim 11, further comprising a substrate layer.

17. The article of claim 12, further comprising a laminating layer overlaying the protective layer.

18. The article of claim 1, wherein the digital data includes multiplexed holographic data.

19. The article of claim 4, wherein the volume hologram layer comprises a photo sensitive polymer.

20. The article of claim 1, wherein the article is a document, a card, a banknote, or merchandise.

21. The article of claim 1, wherein the digital data is multiplexed in substantially a same location as that of an image hologram visible to human eye.

22. The article of claim 1, wherein the digital data is patterned as a two-dimensional pattern of data bits.

23. The article of claim 1, wherein the digital data is a full page of digital data.

24. The article of claim 1, wherein the digital data is patterned as a series of digital data that is read by a scanner.

25. The article of claim 1, wherein the digital data are recorded with a reference beam that is spatially encoded using phase, or amplitude, or both thereby requiring an encoded readout beam to be read the digital data.

26. The article of claim 1, wherein the digital data are recorded and read by UV light.

27. The article of claim 1, further comprising modulation marks for timing and/or positional servo.

28. The article of claim 1, wherein a layer of a photosensitive material is positioned above an optically reflective surface, an optically transmissive surface or an optically absorptive surface.

29. The article of claim 1, wherein the digital data is written into the holographic recording medium before assembling components of the article into the article.

30. The article of claim 1, wherein the digital data is written into the holographic recording medium after assembling components of the article into the article.

31. A method of authentication of an article of claim 1, the method comprising obtaining the article, reading the digital data and determining the authenticity of the article.

32. The method of claim 31, further comprising optically storing the digital data as an image at an image plane by interfering a coherent reference beam with a beam of a two-dimensional image.

33. The method of claim 32, wherein the digital data is arranged in a bitwise pattern for reading the digital data by a compact disk optical head.

34. The method of claim 32, wherein the beam of a two-dimensional image is passed through an intervening optical system that is a spherical afocal telescopic system comprising a multiplicity of optical elements.

35. The method of claim 34, wherein the intervening optical system is an afocal telescopic system comprising two spherical optical lens groups, positioned physically to bring the focal positions of the two spherical optical lens groups into coincidence.

36. The method of claim 35, wherein a single cylindrical imaging optical element is additionally employed.

37. The method of claim 31, wherein a combination of cylindrical and spherical imaging optical elements are employed.

38. The method of claim 31, wherein the holographic recording medium is a holographic material that records volume holograms.
